(19) United States
(12) Patent Application Publication
(10) Pub. No.: US 2026/0316811 A1
(43) Pub. Date: Oct. 15, 2026

(54) FORCE STABILIZATION DEVICE

(71) Applicant: FREEJOGGER APS, Copenhagen (DK)

(72) Inventors: Anne Sofie Buur MEILSOE, Copenhagen (DK); Steffen Jordan MEILSOE, Copenhagen (DK); Steen Buur KREIBERG, Copenhagen (DK)

(21) Appl. No.: 19/484,974

(22) PCT Filed: May 28, 2024
(86) PCT No.: PCT/EP2024/064644

§ 371 Date: Nov. 17, 2025

(30) Foreign Application Priority Data
May 28, 2023 (EP) 23175881.4
Jul. 13, 2023 (DK) PA202330125

(51) Int. Cl. B62B 5/06; B62B 9/20

(52) U.S. Cl. CPC B62B 5/062; B62B 9/20

(57) ABSTRACT

The present description relates to a device (100) for transferring momentum to a vehicle powered by a fluctuating force said device characterised in comprising: a) a force input interface (110) configured for receiving a fluctuating force; b) a force buffering unit (120) configured to convert the fluctuating force into a stabilized force output less fluctuating than the input force; c) a force output interface (130) configured to connect to the vehicle and to transfer the stabilized force to the vehicle; wherein the force input interface comprises a cylinder (111) having a cylinder longitudinal axis, which is rotationally connected to a central shaft (140) having a shaft longitudinal axis, wherein the cylinder axis is parallel to the shaft axis, wherein the cylinder comprises a primary gear (112), and wherein the cylinder or primary gear is connected to a force buffering element (121), wherein the cylinder or primary gear is configured to exchanging rotational force with the buffering element, and wherein the buffering element is capable of accumulating or releasing

### TECHNICAL FIELD

The present disclosure describes a device which attach to a vehicle and stabilizes the force transferred to the vehicle by a fluctuating source of force, such as human movement. Also described are methods for stabililizing fluctuating force applied to a vehicle, and use of the device described herein to apply force to a vehicle.

### BACKGROUND

Vehicles that are powered by human or animal muscle force and movement, whether push or draw movement are well known and includes baby carriers, a baby strollers, a baby joggers, hand carts, utility carts, and wheelbarrows. In particular for those vehicles where movement force is applied by a pushing force it is also known that the fluctuating pushing force applied from eg a human in walking or running motion causes instability in the direction and the balance of both the pushed vehicle as well as for the human pushing it.

Vehicles, such as baby joggers have gained immense popularity among parents and caregivers who want to maintain an active lifestyle while ensuring the comfort and safety of their infants. These specialized strollers allow caregivers to jog or run while providing a secure and comfortable environment for the baby. However, traditional baby joggers often face challenges related to movement stability, which can impact the overall safety and usability of the product. The device described herein addresses the challenges associated with ensuring a smooth, comfortable, and safe ride for both the baby and the caregiver when pushing vehicles such as baby joggers by the fluctuating force of the hands of a human in walking or running motion. The fluctuating force of the hands of a human in walking or running motion may lead to sudden changes in direction or speed, erratic movements, tipping, or even potential accidents, causing concern for the caregiver and endangering the baby's well-being. The potential risks associated with poor movement stabilization underscore the need for innovative solutions that can address these challenges effectively.

Today vehicles such as a baby jogger have handles for pushing the vehicle, but the pushing is burdensome as the handle configuration forces a runner to fix one or both arms and hands in a position to grasp the handle at all times while running. This form is detrimental to the natural running motion that humans have evolved to reduce injuries and improve performance.

Some efforts have been made in the art to improve the comfort of pushed vehicles such as baby joggers, including those described in U.S. Pat. Nos. 6,196,947, 6,722,689, 5,674,165, 9,144,708, 11,097,762, 5,876,309, US20150069738, US20100056348A1, U.S. Pat. Nos. 11,518,425, 11,447,169, US20070126195, WO2022073118, CN115320692, US2015/0217792, U.S. Pat. Nos. 7,311,313 and 11,279,390.

However, these advances do not provide resolution for all the challenges associated with stabilizing the force applied to baby joggers or other hand pushed vehicles from the fluctuating force of a human in walking of running motion and associated with providing for a smooth, comfortable and safe running experience for both bay and the pushing caregiver.

### SUMMARY

Over this background art the present inventors have designed and developed a groundbreaking detachable buffered force transferring device overcoming the limitations of existing solutions and establishing a new standard in the field of hand pushed vehicles—a device that allows for the natural and counter-moving nature of arm movement during bipedal locomotion and which allows for the buffering and transformation of a fluctuating force by a mechanism of choice for absorbing, storing and releasing energy resulting from the fluctuating force, whether this mechanism employs springs, pneumatics, or hydraulics. The device described herein in particular those including forced countermovement of handles, a resistance mechanism and angled handles provide for an excellent and stabile transfer of force and an outstanding running experience.

Accordingly, in a first aspect described herein is a device (100) for stabilizing the movement of a vehicle powered by a fluctuating force said device characterised in comprising:
a) a force input interface (110) configured for receiving a fluctuating force;
b) a force buffering unit (120) configured to convert the fluctuating force into a stabilized force output less fluctuating than the input force;
c) a force output interface (130) configured to connect to the vehicle and to transfer the stabilized force to the vehicle;
   wherein the force input interface comprises a cylinder (111) having a cylinder longitudinal axis, which is rotationally connected to a central shaft (140) having a shaft longitudinal axis, wherein the cylinder axis is parallel to the shaft axis, wherein the cylinder comprises a primary gear (112), and wherein the cylinder or primary gear is connected to a force buffering element (121), wherein the cylinder or primary gear is configured to exchanging rotational force with the buffering element, and wherein the buffering element is capable of accumulating or releasing energy resulting from the exchange of force with the cylinder or primary gear, wherein the force buffering unit is fixed on the central shaft (140) and comprises a secondary gear (122) engaged with the primary gear.

In a further aspect described herein is a method for transforming a fluctuating force comprising connecting the device to a vehicle, applying a fluctuating force to the device, transforming the fluctuating force in the buffering unit and transferring the transformed force to the vehicle.

In a further aspect described herein is the use of the device for applying a force to a vehicle for transporting people/goods.

### DESCRIPTION OF DRAWINGS AND FIGURES

The figures included herein are illustrative and may be simplified for clarity, and they merely show details which are essential to the understanding of the invention, while other details may have been left out. Throughout the specification, claims and drawings the same reference numerals are used for identical or corresponding parts. The figures and drawing include herein:

FIG. 1, which shows the front view of the device.

FIG. 2, which shows the front view of the device including handle angles.

FIG. 3, which shows the side view of the device.

FIG. 4, which shows the perspective view of the device.

FIG. 5, which shows the side view of central shaft, cylinder on one side, primary and secondary bevel gears and perspective view of primary bevel gear and perspective view of cylinder and primary bevel gear.

FIG. 6, which shows the cylinder outer surface.

FIG. 7, which shows the perspective view of central shaft, cylinder on one side, primary and secondary bevel gears.

FIG. 8, which shows the side view, upper perspective and lower perspective view of secondary bevel gear.

FIG. 9, which shows different views of central shaft.

FIG. 10, which shows shows different views of central shaft with bearings.

FIG. 11, which shows shows different views of central shaft with bearing and secondary bevel gears.

FIG. 12, which shows mirrored cylinders with primary bevel gears, secondary bevel gears mounted on the central shaft.

FIG. 13, which shows the same as FIG. 12, but the buffering unit housing.

FIG. 14, which shows the perspective view of various device parts.

FIG. 15, which shows the device with angled output interface connector elements.

FIG. 16, which shows the perspective view of the device with attachment means (strips) for fixing the device to a vehicle. This figure also shows the placement of the device on a vehicle handle.

FIG. 17, which shows the bottom view of the device with attachment means (strips) for fixing the device to a vehicle handle.

FIG. 18, which shows a side view of the device with attachment points and strips.

FIG. 19, which shows a perspective view of mirrored cylinders with primary bevel gears, secondary bevel gears mounted on the central shaft, spring-load mechanisms and buffering unit housing halfshells.

FIG. 20, which shows the buffering unit housing halfshells, with springs and stopper protrusions.

FIG. 21, which shows a perspective view of mirrored cylinders with primary bevel gears, secondary bevel gears mounted on the central shaft, spring-load mechanisms and buffering unit housing halfshells.

FIG. 22, which shows the input force interface and the buffering unit indicating the forced counter movement of the handles.

FIG. 23, which shows a perspective view of the cylinder and bracket

FIG. 24, which shows a perspective of of ladder strap and racket.

### INCORPORATION BY REFERENCE

All publications, patents, and patent applications referred to herein are incorporated by reference to the same extent as if each individual publication, patent, or patent application was specifically and individually indicated to be incorporated by reference. In the event of a conflict between a term herein and a term in an incorporated reference, the term herein prevails and controls.

### DETAILED DESCRIPTION

The features and advantages of the present invention is readily apparent to a person skilled in the art by the below detailed description of embodiments of the invention with reference to the figures and drawings included herein.

### Definitions

The term “fluctuating force” as used herein refers to force which fluctuate in force amplitude, force speed, force frequency or force direction, or a combination thereof.

In the device described herein the fluctuating force, for example the push of a human hand, is transformed into a rotational force or movement of the cylinder (111) by the input interface and the energy created by the force is absorbed and/or accumulated as as potential energy by the force buffering unit and then in turn the accumulated potential energy is released and transferred as kinetic energy back to the cylinder and the central shaft and further to the output interface and the vehicle by the buffering element. In some embodiments by applying the device described herein e.g. to a vehicle it can be avoided or reduced that a fluctuating force and the fluctuation is transferred directly to the vehicle. It can be very undesirable/uncomfortable for passengers and/or cargo in a vehicle driven by a fluctuation force, where the fluctuation manifests itself directly in the vehicle. The device described herein is capable of buffering, absorbing, transferring, cushioning, and/or modulating a force applied to the device fluctuating in amplitude, speed, frequency and/or direction. The buffering unit comprises means, for example a resistance mechanism (see below) configured for absorbing, storing and releasing the energy received from the input fluctuating force.

The term “cylinder” as used herein refers to a cylinder or cylinder-like shaped hollow structure, such as a barrel or tube, designed to house and guide a shaft around which the cylinder can rotate. The cylinder is typically constructed from metal or other durable materials to withstand internal pressures and stresses.

The term “configured for” or “configured to” as used herein refers to a state or condition or structural setting to which a means for, a component, a system, and/or or a method is specifically designed, adapted, arranged, or programmed to perform a particular function or achieve a specific purpose. This may include hardware configurations, software instructions, or any combination thereof that enables the entity to perform the designated function under specified conditions.

The term “capable of” as used herein refers to the inherent ability or potential of a means for, a component, a system, and/or a method to perform a particular function or achieve a specific result, optionally whether or not it is configured to do so. This implies that the entity possesses the necessary attributes, resources, or characteristics that would allow it to perform the designated function when appropriately configured, activated, or utilized under suitable conditions.

The term “rotational force” refers to the force that causes an object to rotate about an axis. This force, often measured in terms of torque, is responsible for inducing angular motion and is characterized by the application of a linear force at a distance from the axis of rotation, resulting in a turning or twisting effect. Rotational force is a fundamental concept in mechanics and is essential in describing the behavior of rotating systems, components, and assemblies. In the device described herein a (linear) force applied to the force input interface (110) is converted into a rotational movement of the cylinder (111) and the primary gear (112), which then applies a force in the secondary gear.

The cylinder of the input interphase suitably has a length (113) in its longitudinal direction of between 50 mm to 250 mm, optionally between 100 mm to 200 mm, optionally between 125 mm to 175 mm, optionally between 145 mm to 155 mm, optionally between 150 mm to 151 mm, while its outer diameter (114) is between 20 mm to 50 mm, optionally between 25 mm to 45 mm, optionally between 30 mm to 40 mm, optionally between 35 mm to 36 mm. The cylinder inner diameter (115) is suitably between 15 mm to 45 mm, optionally between 20 mm to 40 mm, optionally between 25 mm to 35 mm, optionally between 28 mm to 30 mm.

The central shaft of the device suitably has a length (141) in its longitudinal direction of between 15 mm to 45 mm, optionally between 20 mm to 40 mm, optionally between 25 mm to 35 mm, optionally between 28 mm to 30 mm, while its diameter (142) is suitably between 4 mm to 12 mm, optionally between 5 mm to 10 mm, optionally between 6 mm to 8 mm, optionally between 6.5 mm to 7.5 mm. In some embodiments the central shaft has at least two portions (143) which are configured for accommodating at least two bearings between the central shaft and the cylinder in opposite ends of the cylinder. Where the device has mirrored input interfaces the shaft preferably has 4 such bearing portions. These portions (143) preferably comprise a socket (144) configured for receiving a matching socket of the bearings thereby enabling the fixation of the the bearing to the central shaft. In further embodiments it is preferred some portions, preferably those closest to the buffering unit (towards the center of the central shaft for mirrored input interfaces), is configured to accommodate bearings having a larger diameter than other portions—typically distally positioned on the central shaft. These portions for accommodating larger bearings typically have a diameter between 6.9 mm to 7.1 mm, whereas portions configured for accommodating smaller bearings have a diameter between 4.9 mm to 5.1 mm.

The cylinder (111) is rotationally connected to the central shaft via one or more of these bearings (145), and the bearings are suitably selected from ball bearings, roller bearings, needle bearings, plain bearings, tapered bearings, and/or spherical bearings.

The primary gear of the input interface is preferably orthogonally fixed to the cylinder and turns with the rotation of the cylinder (111) around the cylinder's longitudinal axis. The primary gear suitably has a diameter (116) of between 25 mm to 75 mm, optionally between 30 mm to 70 mm, optionally between 35 mm to 65 mm, optionally between 40 mm to 60 mm, optionally between 45 mm to 55 mm, optionally between 51 mm to 53 mm, while it suitably has a thickness (117) between 5 mm to 15 mm, optionally between 7.5 mm to 12.5 mm, optionally between 8 mm to 11 mm, optionally between 9 mm to 10 mm. Further, the primary gear suitably has a central, preferably circular hole (118) allowing passage of the central shaft, including the bearings, said hole suitably having a diameter between 5 mm to 50 mm, optionally between 15 mm to 40 mm, optionally between 25 mm to 30 mm, optionally between 28 mm to 30 mm. In some embodiments the primary gear also comprises a central cutout (119) on the side opposite the teeth, where the cutout matches the outer diameter of the cylinder and allowing the primary gear to be fitted fixed onto the cylinder. The primary gear suitably has between 30 to 70 teeth, optionally between 40 to 60 teeth, optionally between 45 to 55 teeth, optionally between 49 to 51 teeth, and preferably the primary gear is a bevel gear. In further embodiments, the cylinder or primary gear comprises a first protrusion (1101) configured to engage with and activate the force buffering element upon rotation of the cylinder and primary gear. This first protrusion (1101) suitably has cuboid curved shape following the curvature of the cylinder/primary gear and has a side length between 2 mm to 10 mm, optionally between 4 mm to 8 mm, optionally between 5 mm to 7 mm.

The input interface preferably comprises a handle (1102) which adjustably connected to the cylinder (111), so that the position of the handle relative to the cylinder and central shaft where no force is applied to the handle (resting or relaxed state/mode) can be easily changed, in particular with respect to the horizontal position, the rotational position and/or the tilt of the handle. It has been found that an adjustable positioning of the handle is very important for the functional versatility of the device as it greatly adds to movement comfort and running experience of users having different heights and distance between arms. The handle is preferably adjustably connected to the cylinder (111) by a bracket (1103) tightly fitted to the cylinder by fastening means (1104) optionally configured for manual fastening by hand. Thereby the handles position can be adjusted on the go without the use of tools. In some embodiments the bracket comprises a cylinder-shaped part (1105) configured for surrounding the cylinder and two oppositely positioned flange parts (1106) fitting in the fastening means. Thereby the flanges are configured when pressed together by the fastening means to reduce the diameter of the cylinder-shaped part, thereby squeezing the bracket tightly around the cylinder. The fastening means suitable comprises a bolt (1107), optionally engaging into a threading (1108) cut into the bracket or into an oppositely positioned nut. The bolt or the nut suitable comprises means for improving the manual grip, so as to allow the manual tightening of the bolt or nut, for example by further comprising one or more protrusion or flanges on top or on the sides allowing the bolt or nut to be loosened and tightened by hand. In a preferred embodiment the handle is rotationally and/or horizontally adjustable vis-à-vis the cylinder. For improving the grip of the bracket on the cylinder the cylinder comprises in some embodiment an outer surface (1109), which is wholly or partially ridged and comprises one or more grooves and/or protrusions (1110). Preferably, the bracket (103) also comprises similar grooves and/or protrusions (1111) matching the grooves and/or protrusions (1110) of the cylinder outer surface, there locking the handles position ion the cylinder when the bracket is tightened. The distance or pitch (1112) between grooves/protrusions is suitably between 1 mm to 3 mm, optionally between 1.25 mm to 2.25 mm, optionally between 1.5 mm and 2 mm, optionally between 1.7 mm and 1.9mm, while the depth (1113) of the grooves/protrusions suitably is between 0.25 mm to 0.75 mm, optionally between 0.35 mm to 0.65 mm, optionally between 0.45 mm to 0.60 mm, optionally between 0.54 mm to 0.56 mm. In some embodiments, the grooves and/or protrusions have a direction which is parallel to the cylinders longitudinal axis, i.e. orthogonally to the rotational movement of the cylinder, thereby particularly locking the handles position in the direction of the pushing force, even when the bracket is slightly loosened, while still allowing the handle to be slided alongside the axis of the cylinder for horizontal positioning. In other embodiments grooves and/or protrusions have a direction which is orthogonal to the cylinder axis, allowing the handle bracket to slide rotationally around the cylinder's longitudinal axis when the bracket is loosened from the cylinder. In still further embodiments the grooves and/or protrusions forms a threading allowing the handle bracket to slide both horizontally and rotationally around the cylinder's longitudinal axis. The outer surface of the cylinder can further comprise one or more additional deep grooves (1114) preferably having a width between 0.5 mm to 1.5 mm, optionally between 0.75 mm to 1.25 mm, optionally between 1 mm to 1.2 mm and a depth between 0.5 mm to 1.5 mm, optionally between 0.75 mm to 1.25 mm, optionally between 0.8 mm to 1 mm. The handle can further comprise one of more adjustable interconnected bends (1115) and/or spacers (1118) allowing positioning of the handle at different angles (1116) relative to the longitudinal axis of the cylinder and central shaft. This angle also greatly adds to movement comfort and running experience of users having different running styles. In particularly the degree of arm extension when running, results in different hand angles when running and a handle that is orthogonal the the axis of the cylinder and central shaft may not be optimal. In some embodiments the angle (1116) between the handle and the longitudinal axis of the cylinder can therefore be adjusted by rotating the bends and/or spacers. In some embodiments angle (1116) is less than 90°, such as between 60° to 90°, optionally between 70° to 80°. The handle preferably further comprises a sleeve of a soft non-slip material, such as rubber, neoprene or the like. In a particular embodiment device comprise two identical but mirrored mirrored input interfaces placed in each distal end of the central shaft, separated by the buffering unit and interconnected via the secondary gear(s) of the buffering unit. Even more preferred the two mirrored input interfaces are coupled via the secondary gear(s) (122) of the buffering unit (120) so as to provide forced counter movement of the handles. In this context forced counter movement is to be understood as when moving one handle forwards by a push, the primary and secondary gears transmit this movement to a backwards movement of the other handle.

In further embodiments the buffering unit comprises at least two secondary gears (122) both engaged in the primary gear (112) and oppositely positioned on the secondary shafts (123) rigidly fixed onto the central shaft (140). The axis of the secondary shaft(s) and gear(s) is preferably orthogonal to the axis of the primary gear. The base (124) of the secondary gear(s) (122) is suitably between 5 mm to 50 mm, optionally between 7 mm to 30 mm, optionally between 10 mm to 25 mm, optionally between 15 mm to 20 mm, optionally between 16 mm to 18 mm, whereas the top (125) of the secondary gear (122) suitably is between 5 mm to 50 mm, optionally between 7 mm to 30 mm, optionally between 10 mm to 20 mm, optionally between 14 mm to 15 mm. The secondary gear suitably has a thickness (126) of between 5 mm to 20 mm, optionally between 7 mm to 15 mm, optionally between 8 mm to 12 mm, optionally between 9 mm to 10 mm. In further embodiments the secondary gear(s) comprises between 10 to 30 teeth, optionally between 15 to 25 teeth, optionally between 17 to 23 teeth, optionally between 19 mm to 21 teeth. In still further embodiments the secondary gear(s) has a central, preferably circular hole (127) having a diameter of between 5 mm to 15 mm, optionally between 7 mm to 12 mm, optionally between 9 mm to 10 mm. The secondary gear(s) may further comprise a central cutout (128) on the side opposite the teeth, said cutout and hole matching the outer diameter of the secondary shaft allowing the secondary gear to be rotationally fitted onto the secondary shaft. This cutout suitably has a diameter of between 7 mm to 17 mm, optionally between 9 mm to 13 mm, optionally between 10 mm to 12 mm. The secondary gear(s) is preferably a bevel gear. The buffering unit of the device suitably comprises a housing (129) enclosing the buffering element. In preferred embodiments the buffering element is a resistance mechanism, such as a spring-loaded resistance mechanism, a hydraulic resistance mechanism, or a pneumatic resistance mechanisms. For simplicity of design a preferred resistance mechanism is a spring-loaded resistance mechanism (1202). In this embodiment the spring suitably has a length (1203) in it longitudinal direction of between 25 mm to 75 mm, optionally between 35 mm to 65 mm, optionally between 45 mm to 55 mm, optionally between 50 mm to 52 mm, the spring suitably has. a diameter (1204) of between 10 mm 5 mm to 15 mm, optionally between 7.5 mm to 12.5 mm, optionally between 9.5 mm to 10.5 mm. In further embodiments the buffering unit housing comprises a second protrusion (1205) rotationally fixed to the housing and the central shaft and configured to engage with and activate the force buffering element upon rotation of the cylinder and primary gear. The device described is preferably configured to return the cylinders rotational position after a push to a resting or relaxed state/mode. This position can be determined by stoppers setting limits for the rotation of the cylinder or if including two oppositely operating resistance mechanisms by the equilibrium between the forces of these resistance mechanisms. In some embodiments where the force buffering element is a spring-loaded resistance mechanism, the buffering unit housing suitably forms a compartment (1207) comprising the said spring-loaded resistance mechanism (spring), said compartment being formed from the housing walls (1206), the cylinder (111), the first protrusion (1101) of the cylinder or primary gear and the second protrusion (1205) of the buffering unit housing, whereby the protrusions forming stoppers in opposite distal ends of the compartment, which when rotating the cylinder expands or shrinks the compartment and thereby compress or decompress the spring and thus accumulating or releasing energy. In some embodiments the spring-loaded resistance mechanism can be adjusted to exercise different levels of resistance allowing the runner to adjust the rotational force of the cylinder or primary gear required for compression of the spring to a personal preference. The buffering unit is preferably positioned on the central shaft between the two mirrored input interfaces and is configured for the coupling of the two mirrored input interfaces providing for the forced counter movement of the handles, by having the secondary gear(s) engage with the primary gears of both input interfaces, and wherein the buffering element also preferably comprises two separate mirrored spring-load resistance mechanisms comprised in separate compartments (1207) of the buffering unit housing, each where the first protrusions (1101) and second protrusions (1205) are stoppers forming walls in opposite distal ends of each compartment, which upon rotation of the cylinders expands or shrinks the compartments and thereby compress or decompress the springs thereby accumulating or releasing energy. The housing suitably encases and protects the the buffering element and the primary gear(s) and comprises two halfshells (1201) fitted together by fastening means (1208), such as screws, elastic straps, magnets or interlocking mechanisms between the two halfshells.

The output interface (130) is suitably connected to the central shaft or the cylinder, optionally in an outmost distal end (146), and is configured for connecting the device to the vehicle, optionally to a handle of the vehicle. The output interface (130) and the central shaft is suitably connected by fastening means, such as screws or a socket connection having a male protruding component (147) configured to fit into a corresponding female component (1501) with a hollowed-out socket. The output interface (130) preferably comprises (i) a first connector element (150) connecting to the central shaft or the cylinder, (ii) a second connector element (151) joined to the first connector element by a first joint (152) and comprising one or more attachment points (153) for attaching the second connector element to the vehicle and (iii) a third connector element (154) joined to the second connector element by a second joint (155) and comprising one or more further attachment points (153) for attaching the third connector element to the vehicle. This design allows for adjustment of the output interface to different vehicle parts increasing the versatility and utility of the device. The first and the second joints can be selected from fixed joints, revolute or pivot joints, prismatic joints, ball and socket joints, planar joints, universal joints also known as a cardan joints, or cylindrical joint of a combination thereof. In some embodiments the first and the second joints (152/155) are pivot joints, optionally having one or more matching taps fitted into each other held together with a central pin. In some embodiments the connector elements of the output interface are flexibly joint, allowing the positioning of the connector elements to be adjusted in at least two dimensions relative to each other. The attachment points are suitably cut-outs or holes in the connector element configured for accommodating fastening means (157) fitted into the attachment points and configured for fastening the connector element to the vehicle. These fastening means (157) are preferably adjustable and releasable and configured for fastening and leasing the connector element to the vehicle, so that the device can easily be moved from one vehicle to another. The fastening means (157) are suitably selected from strips, claws, elastic bands, hook and loop bands, or the like. In a preferred embodiment the fastening means (157) is a strip comprising a ladderstap (158) and a racket (159). The length of the first connector element in its longitudinal direction is suitably between 25 mm to 75 mm, optionally between 40 mm to 50 mm, optionally between 40 mm to 50 mm, optionally between 47 mm to 49 mm, while the length of the second connector element in its longitudinal direction suitably is between 150 mm to 200 mm, optionally between 170 mm to 190 mm, optionally between 181 mm to 183 mm. The length of the third connector element in its longitudinal direction is suitably between 50 mm to 100 mm, optionally between 60 mm to 80 mm, optionally between 70 mm to 72 mm. The combined length of the output interface in its longitudinal direction including the the first, second and third connector element is suitably between 225 mm to 500 mm long, optionally between 250 mm to 400 mm long, optionally between 275 mm to 350 mm, optionally between 300 mm to 302 mm.

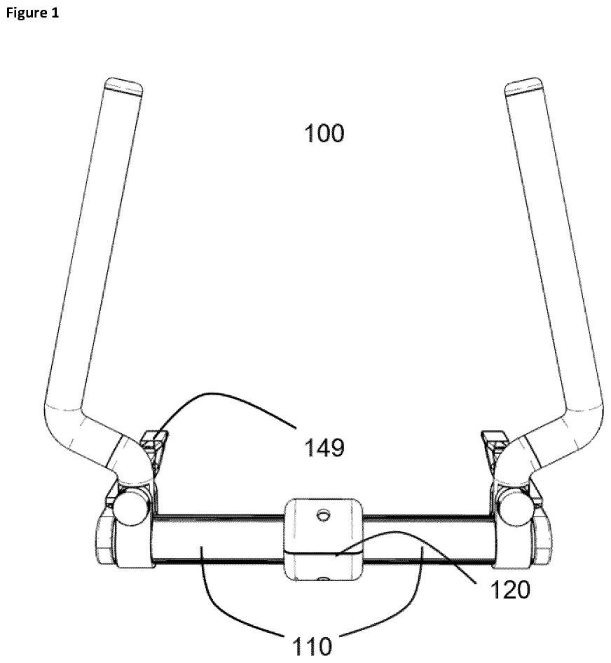

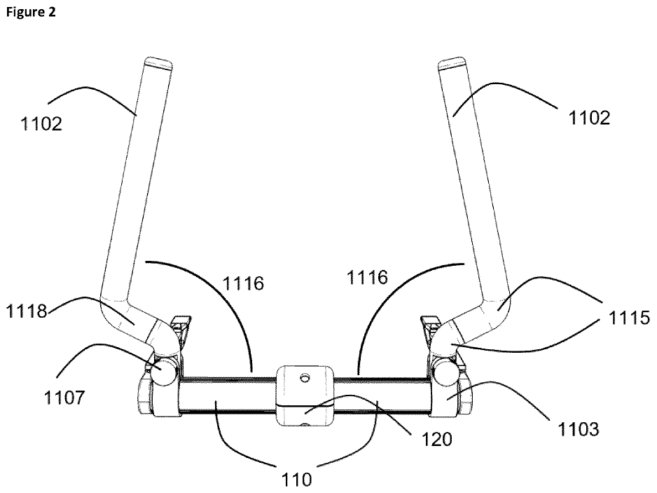

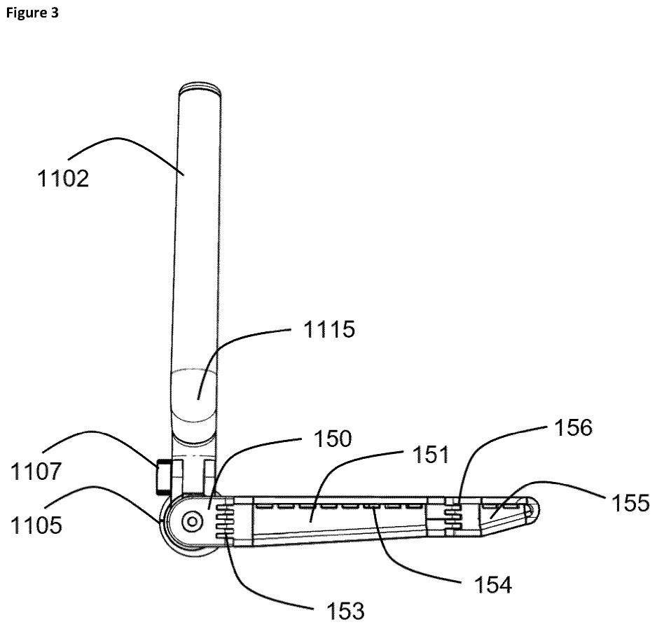

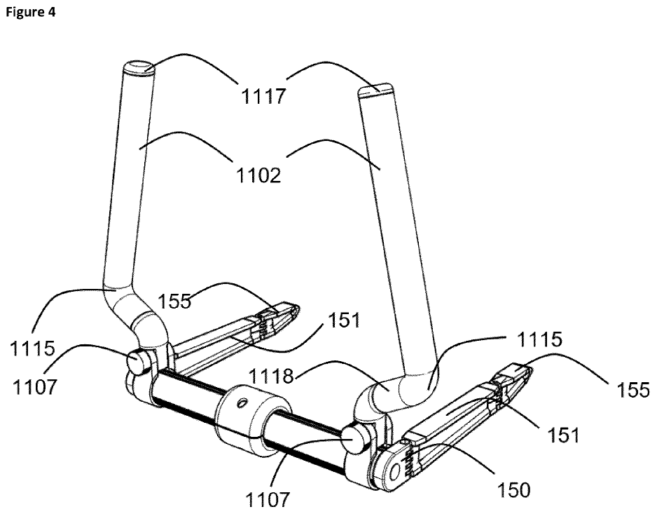

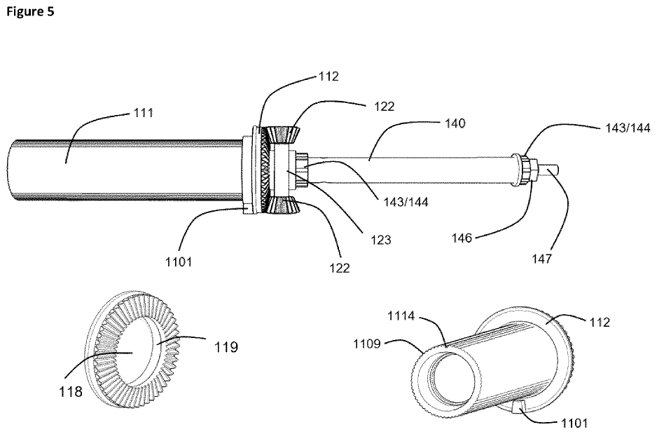

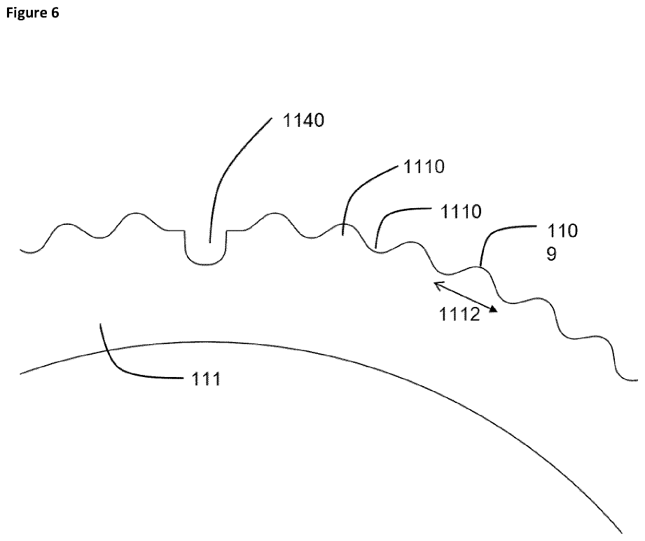

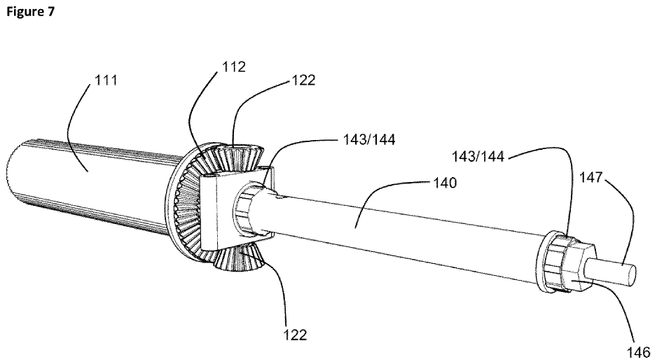

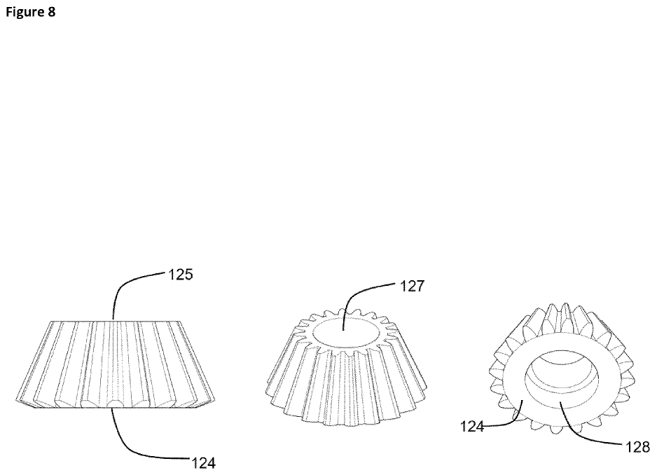

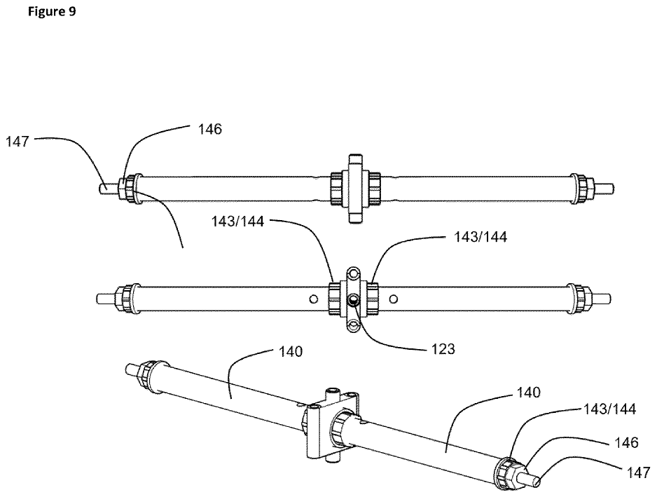

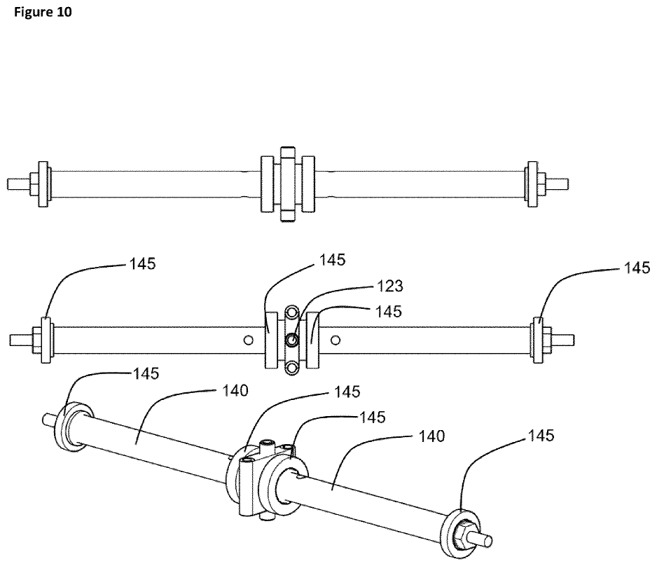

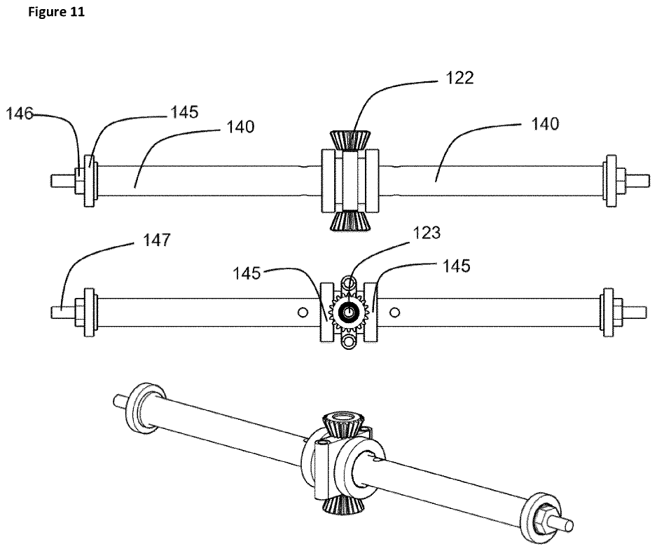

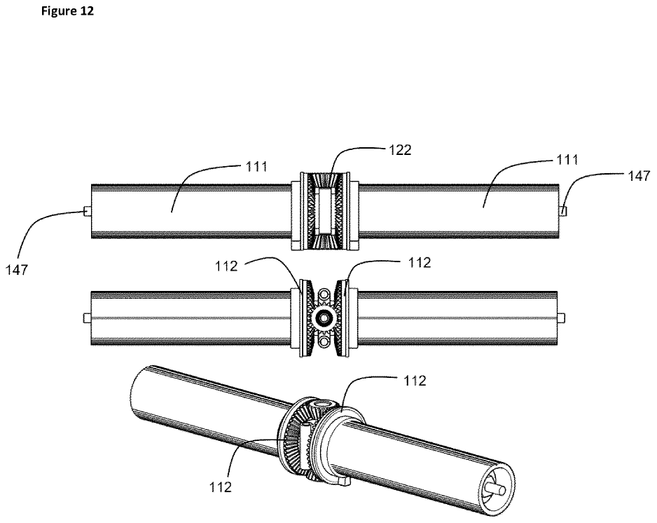

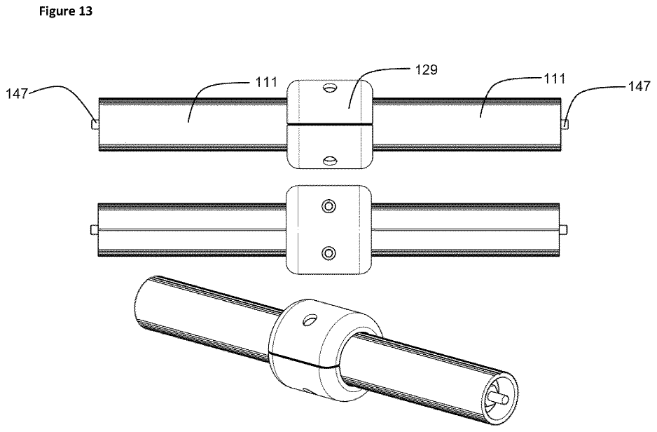

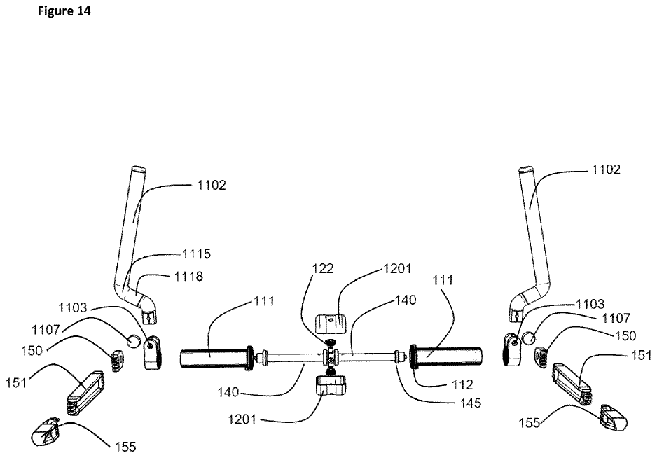

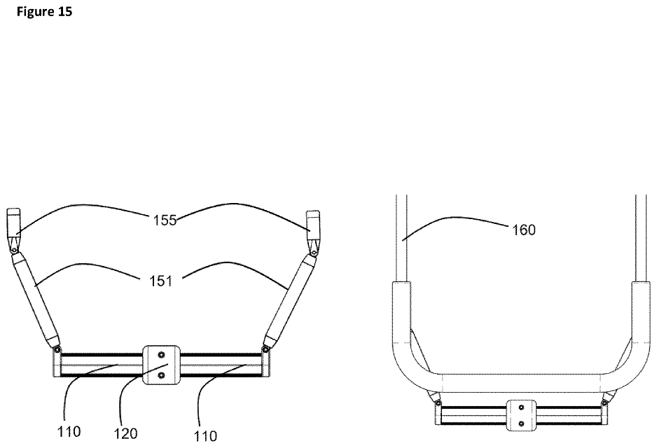

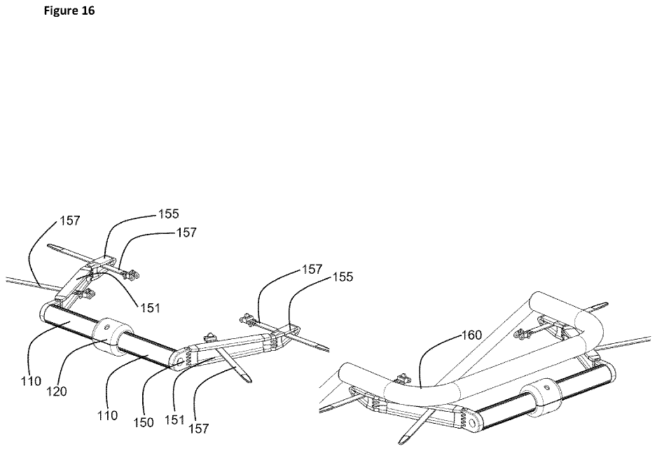

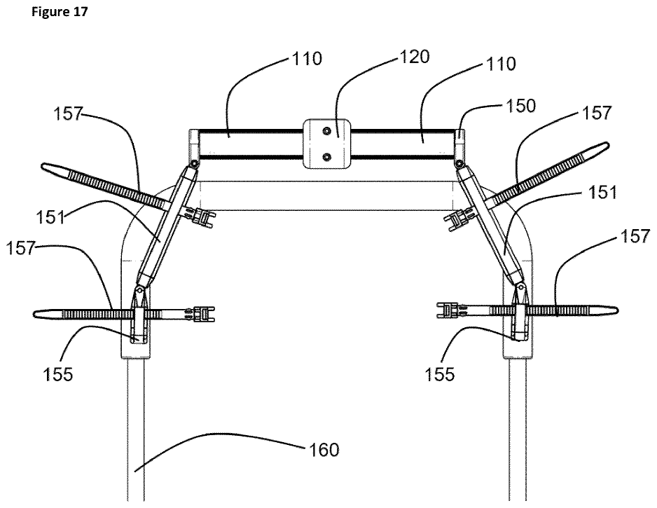

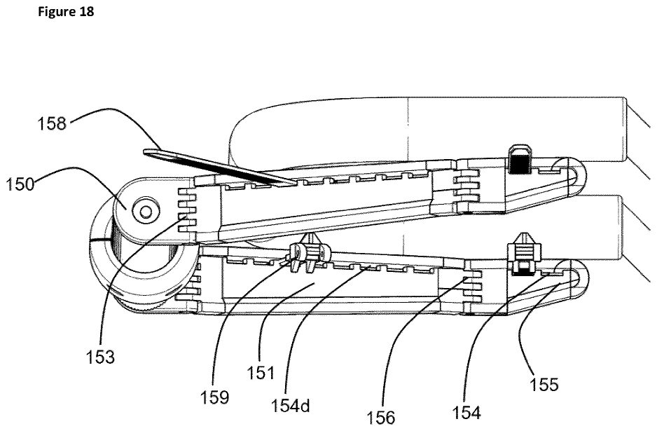

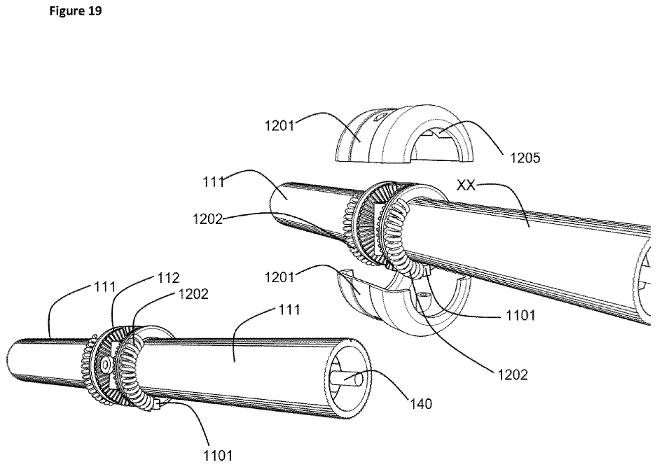

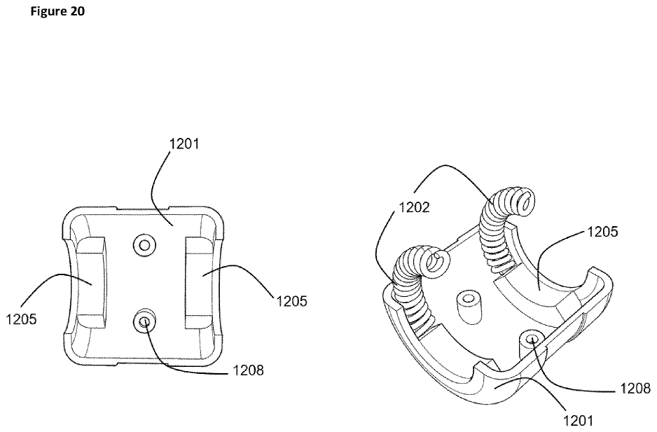

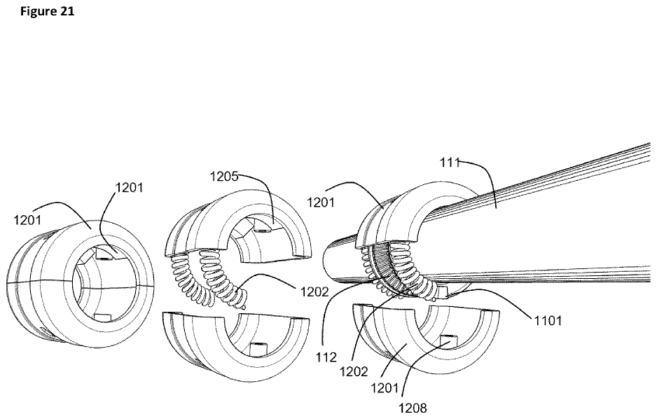

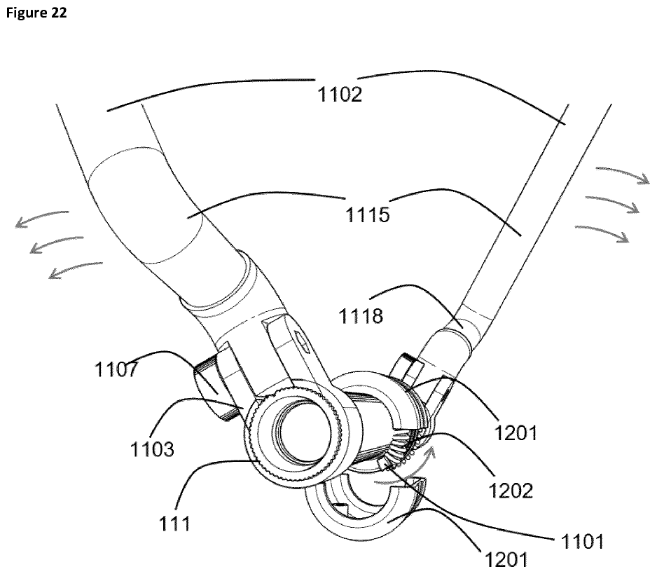

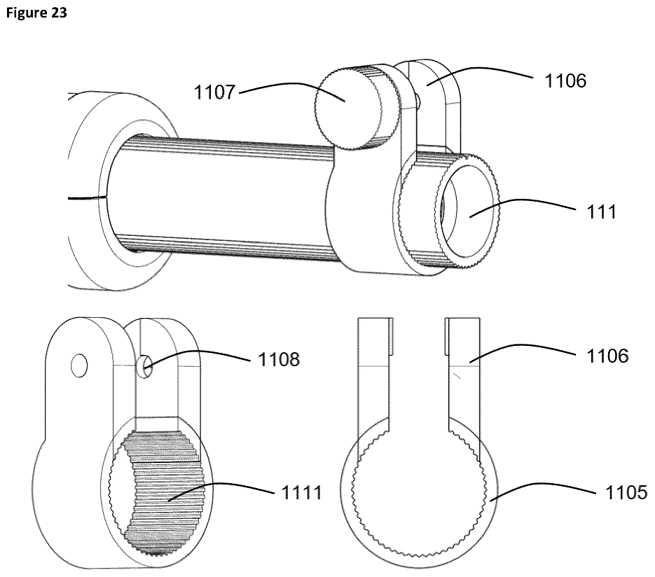

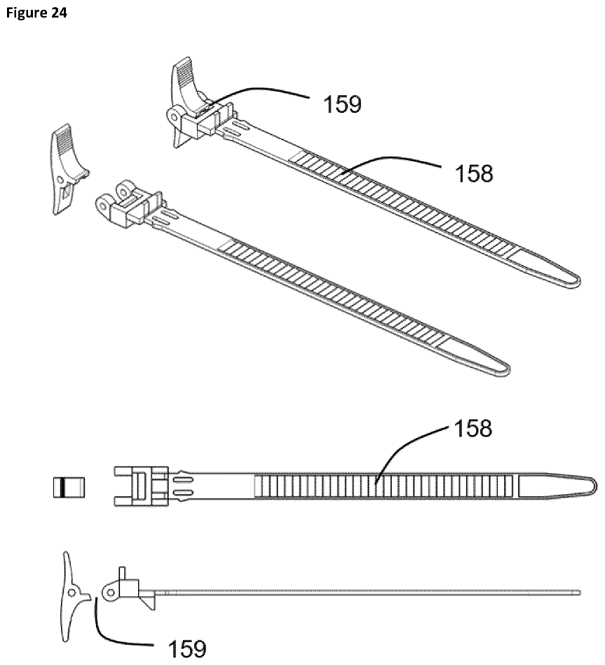

In a most preferred embodiment the device comprises the features as shown in FIGS. 1 to 24.

The device described herein comprises a synthetic polymeric material, optionally reinforced by inorganic fibres. Suitably the cylinder, the central shaft, the buffering unit housing and the output interface connector elements comprises the synthetic polymeric material reinforced by inorganic fibres. The synthetic polymeric material of the cylinder, the central shaft, the buffering unit housing and the output interface connector elements is suitably a polyamid (nylon) and the inorganic fibres are glass fibres or any composites thereof. The synthetic polyamid of these device elements suitably comprises between 10% to 50% glass fibres, optionally between 20% to 40%, optionally between 25% to 35%, optionally between 29% to 31%. In some embodiments the polyamid is a polyamid 6. In other embodiment gears comprise a polyoxymethylene (POM) synthetic polymeric material. In further embodiments the handle also comprises a synthetic polymeric material reinforced by inorganic fibres. For the handles the synthetic polymeric material is suitably a polypropylene (PP) and the inorganic fibres are glass fibres or any composites thereof. The polypropylene (PP) of the handles suitably comprises between 10% to 50% glass fibres, optionally between 20% to 40%, optionally between 25% to 35%, optionally between 29% to 31%. Where the fastening means configured for fastening the connector element to the vehicle are strips they suitably comprises a thermoplastic polyolefin polymer allowing for both high flexibility and durability. The non-slip sleeve of the handle suitably comprises a thermoplastic elastomer. Where the resistance mechanism is a spring-load mechanism, the spring is suitably made of stainless steel, or galvanized steel or a functional alloy thereof. Where the handle comprises a bolt and optionally a nut, the bolt and optional nut is suitably made from steel or a functional alloy thereof or alternative made from a synthetic polymeric, optionally a polyamid (nylon). Where the means for fastening the first connector element of the output interface to the central shaft is a screw, the screw is suitably made of steel or a functional alloy thereof. The bearings can be made from a steel alloy or molded in nylon.

The fluctuating power is the push from a body part of a human in walking or running motion, typically the push from the hand and the vehicle to be hand pushed can be selected from baby carriers, baby strollers, baby joggers, hand carts, utility carts, or wheelbarrows.

Also described herein is a method for transforming a fluctuating force comprising connecting the device described herein to a vehicle, applying a fluctuating force to the device, transforming the fluctuating force in the buffering unit and transfer the transformed force to the vehicle. The method thereby transforms the alternating momentum of a human in walking or running motion and transfers this momentum to the vehicle in a smooth and less fluctuating manner.

Also described herein is the use the device for applying a force from a human walker or runner to a vehicle.

### Working Examples

A device with two mirrored input interfaces was made according to FIGS. 1 to 24, wherein cylinder, central shaft, buffering unit housing, secondary shafts and connector elements was made from PA6 30GF (Polyamide 6 with 30% glass fiber) by mold injection. The primary and secondary bevel gears was made from polyoxymethylene nby mold injection. The handles were made from PP 30GF (Polypropylene with 30% glass fiber) by mold injection, while the non-slip sleeve on handles where a commercially available thermoplastic elastomers sleeve. The strips for fastening the device to a vehicle was of the ladder strap and racket type made from thermoplastic Polyolefins and produced by mold injection. Springs and screws where commercially available components.

This divide provided for excellent utility on tested vehicles and a super runner/walker experience.

### REFERENCES

(100): Stabilizing device
(110): force input interface
(111): Cylinder
(112): Primary gear
(113): Cylinder length
(114): Cylinder outer diameter
(115): Cylinder inner diameter
(116): Primary gear diameter
(117): Primary gear thickness
(118): Primary gear central hole
(119): Primary gear cutout
(1101): First protrusion for engaging the force buffering element
(1102): Handle
(1103): Bracket
(1104): Bracket fastening means
(1105): Bracket cylinder
(1106): Bracket flange
(1107): Bracket bolt
(1108): Bracket threading for bolt
(1109): Cylinder outer surface
(1110): Cylinder outer surface grooves/protrusions
(1111): Bracket grooves/protrusions
(1112): Grooves/protrusions pitch/distance
(1113): Grooves/protrusions depth
(1114): Cylinder deep groove
(1115): Handle bend
(1116): Handel angle
(1117): Handle stopper
(1118): Handle spacer
(120): force buffering unit
(121): Force buffering element
(122): Secondary gear
(123): Secondary shafts
(124): Secondary gear base
(125): Secondary gear top
(126): Secondary gear thickness
(127): Secondary gear central hole
(128): Secondary gear cutout
(129): Force buffering unit housing
(1201): Force buffering unit housing halfshell
(1202): Spring-load mechanism
(1203): Spring length
(1204): Spring diameter
(1205): Second protrusion for engaging the force buffering element
(1206): Housing wall
(1207): Spring compartment
(1208): Fastening means for assembling buffering unit housing.
(140): Central shaft
(141): Central shaft length
(142): Central shaft diameter
(143): Central shaft bearing portion
(144): Central shaft bearing socket
(145): Central shaft bearings
(146): Central shaft distal end
(147): Central shaft male protrusion
(149): Force output unit
(150): First connector element
(151): Second connector element
(153): First joint
(154): Attachment points
(155): Third connector element
(156): Second joint
(157): Fastening means for connector elements
(158): Ladder strap
(159): Ladder strap racket
(1501): female hollowed-out socket
(160): Vehicle

1. A device (100) for transferring momentum to a vehicle powered by a fluctuating force said device characterised in comprising:
a) a force input interface (110) configured for receiving a fluctuating force;
b) a force buffering unit (120) configured to convert the fluctuating force into a stabilized force output less fluctuating than the input force;
c) a force output interface (130) configured to connect to the vehicle and to transfer the stabilized force to the vehicle;
wherein the force input interface comprises a cylinder (111) having a cylinder longitudinal axis, which is rotationally connected to a central shaft (140) having a shaft longitudinal axis, wherein the cylinder axis is parallel to the shaft axis, wherein the cylinder comprises a primary gear (112), and wherein the cylinder or primary gear is connected to a force buffering element (121), wherein the cylinder or primary gear is configured to exchanging rotational force with the buffering element, and wherein the buffering element is capable of accumulating or releasing energy resulting from the exchange of force with the cylinder or primary gear,
wherein the force buffering unit is fixed on the central shaft (140) and comprises a secondary gear (122) engaged with the primary gear.

2. The device of claim 1, wherein the fluctuating force is transformed into a rotational force or movement of the cylinder (111) by the input interface.

3. The device of any preceding claim, wherein the cylinder has a length (113) in its longitudinal direction of between 50 mm to 250 mm, optionally between 100 mm to 200 mm, optionally between 125 mm to 175 mm, optionally between 145 mm to 155 mm, optionally between 150 mm to 151 mm.

4. The device of any preceding claim, wherein the cylinder has an outer diameter (114) of between 20 mm to 50 mm, optionally between 25 mm to 45 mm, optionally between 30 mm to 40 mm, optionally between 35 mm to 36 mm.

5. The device of any preceding claim, wherein the cylinder has an inner diameter (115) of between 15 mm to 45 mm, optionally between 20 mm to 40 mm, optionally between 25 mm to 35 mm, optionally between 28 mm to 30 mm.

6. The device of any preceding claim, wherein the central shaft has a length (141) in its longitudinal direction of between 15 mm to 45 mm, optionally between 20 mm to 40 mm, optionally between 25 mm to 35 mm, optionally between 28 mm to 30 mm.

7. The device of any preceding claim, wherein the central shaft has a diameter (142) of between 4 mm to 12 mm, optionally between 5 mm to 10 mm, optionally between 6 mm to 8 mm, optionally between 6.5 mm to 7.5 mm.

8. The device of any preceding claim, wherein the central shaft has at least two portions (143) configured for accommodating at least two bearings between the central shaft and the cylinder in opposite ends of the cylinder.

9. The device of claim 8, wherein the at least two portions (143) comprise a socket (144) configured for receiving a matching socket of the bearings thereby fastening the bearing to the central shaft.

10. The device of claim 8 to 9, wherein one portion is configured for accommodating a bearing has a larger diameter than the other portion configured for accommodating a bearing.

11. The device of claim 8 to 10, wherein one portion configured for accommodating a bearing has a diameter between 6.9 mm to 7.1 mm and the other portion configured for accommodating a bearing has a diameter between 4.9 mm to 5.1 mm.

12. The device of any preceding claim, wherein the cylinder (111) is rotationally connected to the central shaft via one or more bearings (145), optionally a ball bearing, a roller bearings, a needle bearings, a plain bearings, a tapered bearings, or a spherical bearings.

13. The device of claim 3 to 12, wherein the cylinder has a length (113) in its longitudinal direction of between 150 mm to 151 mm, wherein the cylinder has an outer diameter (114) of between 35 mm to 36 mm, wherein the cylinder has an inner diameter (115) of between 28 mm to 30 mm, and wherein the cylinder (111) is rotationally connected to the central shaft via one or more bearings (145).

14. The device of claim 3 to 13, wherein the central shaft has a length (141) in its longitudinal direction of between 28 mm to 30 mm, wherein the central shaft has a diameter (142) of between 6.5 mm to 7.5 mm, wherein the central shaft has at least two portions (143) configured for accommodating at least two bearings between the central shaft and the cylinder in opposite ends of the cylinder, wherein the at least two portions (143) comprise a socket (144) configured for receiving a matching socket of the bearings thereby fastening the bearing to the central shaft, wherein one portion has a diameter between 6.9 mm to 7.1 mm and the other portion configured for accommodating a bearing has a diameter between 4.9 mm to 5.1 mm.

15. The device of any preceding claim, wherein the primary gear is rigidly and orthogonally fixed to the cylinder and turns with the rotation of the cylinder (111) around the cylinder's longitudinal axis.

16. The device of any preceding claim, wherein the primary gear has a diameter (116) of between 25 mm to 75 mm, optionally between 30 mm to 70 mm, optionally between 35 mm to 65 mm, optionally between 40 mm to 60 mm, optionally between 45 mm to 55 mm, optionally between 51 mm to 53 mm.

17. The device of any preceding claim, wherein the primary gear has a thickness (117) of between 5 mm to 15 mm, optionally between 7.5 mm to 12.5 mm, optionally between 8 mm to 11 mm, optionally between 9 mm to 10 mm.

18. The device of any preceding claim, wherein the primary gear has central, preferably circular hole (118) allowing passage of the central shaft having a diameter of between 5 mm to 50 mm, optionally between 15 mm to 40 mm, optionally between 25 mm to 30 mm, optionally between 28 mm to 30 mm.

19. The device of any preceding claim, wherein the primary gear comprises between 30 to 70 teeth, optionally between 40 to 60 teeth, optionally between 45 to 55 teeth, optionally between 49 to 51 teeth.

20. The device of any preceding claim, wherein the primary gear further comprises a central cutout (119) on the side opposite the teeth, said cutout matching the outer diameter of the cylinder and allowing the primary gear to be fitted fixed onto the cylinder.

21. The device of any preceding claim, wherein the primary gear is a bevel gear.

22. The device of any preceding claim, wherein the primary gear is rigidly and orthogonally fixed to the cylinder and turns with the rotation of the cylinder (111) around the cylinder's longitudinal axis, wherein the primary gear has a diameter (116) of between 51 mm to 53 mm, wherein the primary gear has a thickness (117) of between between 9 mm to 10 mm, wherein the primary gear has central circular hole (118) allowing passage of the central shaft having a diameter of between 28 mm to 30 mm, wherein the primary gear comprises between 49 to 51 teeth, wherein the primary gear further comprises a central cutout (119) on the side opposite the teeth, said cutout matching the outer diameter of the cylinder and allowing the primary gear to be fitted fixed onto the cylinder, and wherein the primary gear is a bevel gear.

23. The device of any preceding claim, wherein the cylinder or primary gear further comprises a first protrusion (1101) configured to engage with and activate the force buffering element upon rotation of the cylinder and primary gear.

24. The device of claim 23, wherein the first protrusion (1101) is cuboid and has a side length between 2 mm to 10 mm, optionally between 4 mm to 8 mm, optionally between 5 mm to 7 mm.

25. The device of claim 23 to 24, wherein the first protrusion (1101) is configured to engage with and activate the force buffering element upon rotation of the cylinder and primary gear, and wherein the first protrusion (1101) is cuboid and has a side length between 5 mm to 7 mm.

26. The device of any preceding claim, wherein the input interface comprises a handle (1102) which adjustably connected to the cylinder (111).

27. The device of claim 26, wherein the handle is adjustably connected to the cylinder (111) by a bracket (1103) tightly fitted to the cylinder by fastening means (1104) optionally configured for fastening by hand.

28. The device of claim 27, wherein the bracket comprises a cylinder-shaped part (1105) configured for surrounding the cylinder and two oppositely positioned flange parts (1106) fitting in the fastening means.

29. The device of claim 27 to 28, wherein the fastening means comprises a bolt (1107), optionally engaging into a threading (1108) cut into the bracket or into a nut.

30. The device of claim 29, wherein the bolt or nut comprises one or more protrusion or flanges allowing the bolt or nut to be manually loosened and tightened by hand.

31. The device of claim 27 to 30, wherein the handle is rotationally and/or horizontally adjustable vis-à-vis the cylinder.

32. The device of claim 26 to 31, wherein the input interface comprises a handle (1102) which is adjustably connected to the cylinder (111), wherein the handle is adjustably connected to the cylinder (111) by a bracket (1103) tightly fitted to the cylinder by fastening means (1104) optionally configured for fastening by hand, wherein the bracket comprises a cylinder-shaped part (1105) configured for surrounding the cylinder and two oppositely positioned flange parts (1106) fitting in the fastening means, wherein the fastening means comprises a bolt (1107), optionally engaging into a threading (1108) cut into the bracket or into a nut, wherein the bolt or nut comprises one or more protrusion or flanges allowing the bolt or nut to be manually loosened and tightened by hand, and wherein the handle is rotationally and/or horizontally adjustable vis-à-vis the cylinder.

33. The device of any preceding claim, wherein the cylinder comprises an outer surface (1109), which surface is wholly or partially ridged and comprises one or more grooves and/or protrusions (1110).

34. The device of claim 27 to 33, wherein the bracket (103) comprises one or more grooves and/or protrusions (1111) matching the grooves and/or protrusions (1110) of the cylinder outer surface.

35. The device of claim 33 to 34, wherein the distance or pitch (1112) between grooves/protrusions is between 1 mm to 3 mm, optionally between 1.25 mm to 2.25 mm, optionally between 1.5 mm and 2 mm, optionally between 1.7 mm and 1.9 mm.

36. The device of claim 33 to 35, wherein the depth (1113) of the grooves/protrusions is between 0,25 mm to 0.75 mm, optionally between 0.35 mm to 0.65 mm, optionally between 0.45 mm to 0.60 mm, optionally between 0.54 mm to 0.56 mm.

37. The device of claim 33 to 36, wherein the grooves and/or protrusions have a direction which is parallel to the cylinder longitudinal axis, allowing the handle bracket to slide in parallel to the cylinder's longitudinal axis when the bracket is loosened from the cylinder.

38. The device of claim 33 to 36, wherein the grooves and/or protrusions have a direction which is orthogonal to the cylinder axis, allowing the handle bracket to slide rotationally around the cylinder's longitudinal axis when the bracket is loosened from the cylinder.

39. The device of claim 33 to 38 wherein the grooves and/or protrusions is a threading allowing the handle bracket to slide both in parallel to rotationally around the cylinder's longitudinal axis.

40. The device of claim 33 to 39, wherein the outer surface of the cylinder comprises one or more additional deep grooves (1114) having a width between 0.5 mm to 1.5 mm, optionally between 0.75 mm to 1.25 mm, optionally between 1 mm to 1.2 mm and a depth between 0.5 mm to 1.5 mm, optionally between 0.75 mm to 1.25 mm, optionally between 0.8 mm to 1 mm.

41. The device of claim 33 to 40, wherein the cylinder comprises an outer surface (1109), which surface is wholly or partially ridged and comprises one or more grooves and/or protrusions (1110), wherein the bracket (103) comprises one or more grooves and/or protrusions (1111) matching the grooves and/or protrusions (1110) of the cylinder outer surface, wherein the distance or pitch (1112) between grooves/protrusions is between 0.7 mm and 1.9 mm, wherein the depth (1113) of the grooves/protrusions is between 0.54 mm to 0.56 mm, wherein (i) the grooves and/or protrusions have a direction which is parallel to the cylinder longitudinal axis, allowing the handle bracket to slide in parallel to the cylinder's longitudinal axis when the bracket is loosened from the cylinder, or (ii) the grooves and/or protrusions have a direction which is orthogonal to the cylinder axis, allowing the handle bracket to slide rotationally around the cylinder's longitudinal axis when the bracket is loosened from the cylinder, or (iii) wherein the grooves and/or protrusions is a threading allowing the handle bracket to slide both in parallel to rotationally around the cylinder's longitudinal axis, and wherein the outer surface of the cylinder comprises one or more additional deep grooves (1114) having a width between 0.8 mm to 1 mm.

42. The device of claim to 26 to 40, wherein the handle comprises one of more adjustable interconnected bends (1115) allowing positioning of the handle at different angles (1116) relative to the longitudinal axis of the cylinder.

43. The device of claim 42, wherein the angle (1116) between the handle and the longitudinal axis of the cylinder can be adjusted by rotating the bends.

44. The device of claim 43 wherein angle (1116) is less than 90°.

45. The device of claim 44 wherein angle (1116) is between 60° to 90°, optionally between 70° to 80°.

46. The device of claim 26 to 45, wherein the handle further comprises a sleeve of a non-slip material.

47. The device of claim 46 wherein the handle comprises one of more adjustable interconnected bends (1115) allowing positioning of the handle at different angles (1116) relative to the longitudinal axis of the cylinder, wherein the angle (1116) between the handle and the longitudinal axis of the cylinder can be adjusted by rotating the bends, wherein the angle (1116) is between 70° to 80°, and wherein the handle further comprises a sleeve of a non-slip material.

48. The device of any preceding claim comprising two mirrored input interfaces in each distal end of the central shaft, separated by the buffering unit and interconnected via the secondary gear(s) of the buffering unit.

49. The device of claim 48 wherein the two mirrored input interfaces are coupled via the secondary gear(s) (122) of the buffering unit (120) to provide forced counter movement of the handles.

50. The device of any preceding claim wherein the buffering unit comprises at least two secondary gears (122) both engaged in the primary gear (112), said two secondary gears being oppositely positioned on secondary shaft(s) (123) rigidly fixed onto the central shaft (140).

51. The device of any preceding claim wherein the axis of the secondary shaft(s) and gear(s) is orthogonal to the axis of the primary gear.

52. The device of any preceding claim, wherein the base (124) of the secondary gear(s) (122) is between 5 mm to 50 mm, optionally between 7 mm to 30 mm, optionally between 10 mm to 25 mm, optionally between 15 mm to 20 mm, optionally between 16 mm to 18 mm.

53. The device of any preceding claim, wherein the top (125) of the secondary gear (122) is between 5 mm to 50 mm, optionally between 7 mm to 30 mm, optionally between 10 mm to 20 mm, optionally between 14 mm to 15 mm.

54. The device of any preceding claim, wherein the secondary gear(s) has a thickness (126) of between 5 mm to 20 mm, optionally between 7 mm to 15 mm, optionally between 8 mm to 12 mm, optionally between 9 mm to 10 mm.

55. The device of any preceding claim, wherein the secondary gear(s) comprises between 10 to 30 teeth, optionally between 15 to 25 teeth, optionally between 17 to 23 teeth, optionally between 19 mm to 21 teeth.

56. The device of any preceding claim, wherein the secondary gear(s) has a central, preferably circular hole (127) having a diameter of between 5 mm to 15 mm, optionally between 7 mm to 12 mm, optionally between 9 mm to 10 mm.

57. The device of any preceding claim, wherein the secondary gear(s) further comprises a central cutout (128) on the side opposite the teeth, said cutout and hole matching the outer diameter of the secondary shaft allowing the secondary gear to be rotationally fitted onto the secondary shaft, the cutout having a diameter of between 7 mm to 17 mm, optionally between 9 mm to 13 mm, optionally between 10 mm to 12 mm.

58. The device of any preceding claim, wherein the secondary gear(s) is a bevel gear.

59. The device of claim 50 to 58 wherein the buffering unit comprises two secondary gears (122) each having a top (125) and a base (124), both secondary gears engaged in the primary gear (112), said two secondary gears being oppositely positioned on secondary shaft(s) (123) rigidly fixed onto the central shaft (140), wherein the axis of the secondary shaft(s) and gear(s) is orthogonal to the axis of the primary gear, wherein the base (124) of the secondary gear(s) (122) is between 16 mm to 18 mm, wherein the top (125) of the secondary gear (122) is between 14 mm to 15 mm, wherein the secondary gear(s) has a thickness (126) of between 9 mm to 10 mm, wherein the secondary gear(s) comprises between 19 to 21 teeth, wherein the secondary gear(s) has a central circular hole (127) having a diameter of between 9 mm to 10 mm, wherein the secondary gear(s) further comprises a central cutout (128) on the side opposite the teeth, said cutout and hole matching the outer diameter of the secondary shaft allowing the secondary gear to be rotationally fitted onto the secondary shaft, the cutout having a diameter of between 10 mm to 12 mm, and wherein the secondary gear(s) is a bevel gear.

60. The device of any preceding claim wherein the buffering unit further comprises a housing (129) enclosing the buffering element.

61. The device of claim 60 wherein the buffering element is a resistance mechanism.

62. The device of claim 61 wherein the resistance mechanism is selected from a spring-loaded resistance mechanism, a hydraulic resistance mechanism, or a pneumatic resistance mechanisms.

63. The device of claim 61 to 62 wherein the resistance mechanism is a spring-loaded resistance mechanism (1202) and wherein the spring has a length (1203) in it longitudinal direction of between 25 mm to 75 mm, optionally between 35 mm to 65 mm, optionally between 45 mm to 55 mm, optionally between 50 mm to 52 mm.

64. The device of claim 61 to 63 wherein the wherein the spring has a diameter (1204) of between 10 mm 5 mm to 15 mm, optionally between 7.5 mm to 12.5 mm, optionally between 9.5 mm to 10.5 mm.

65. The device of claim 60 to 64 wherein the buffering unit housing comprises a second protrusion (1205) rotationally fixed to the housing and configured to engage with and activate the force buffering element upon rotation of the cylinder and primary gear.

66. The device of claim 60 to 65 wherein the buffering unit further comprises a housing (129) enclosing the buffering element, wherein the buffering element is a resistance mechanism, wherein the resistance mechanism is a spring-loaded resistance, wherein the spring has a length (1203) in it longitudinal direction of between 50 mm to 52 mm, wherein the spring has a diameter (1204) of between 9.5 mm to 10.5 mm, and wherein the buffering unit housing comprises a second protrusion (1205) rotationally fixed to the housing and configured to engage with and activate the force buffering element upon rotation of the cylinder and primary gear.

67. The device of any preceding claim configured to return the cylinder to a position where the force buffering element is in a resting or relaxed state/mode when no force is applied to the input interface.

68. The device of any preceding claim wherein the force buffering element is a spring-loaded resistance mechanism and the buffering unit housing forms a compartment (1207) comprising the said spring-loaded resistance mechanism, said compartment being formed from the housing walls (1206), the cylinder (111), the first protrusion (1101) of the cylinder or primary gear and the second protrusion (1205) of the buffering unit housing said protrusions forming stoppers in opposite distal ends of the compartment, which upon rotation of the cylinder expands or shrinks the compartment and thereby compress or decompress the spring accumulating or releasing energy.

69. The device of claim 62 to 68 wherein the spring-loaded resistance mechanism is adjustable allowing for adjustment of the rotational force of the cylinder or primary gear required for compression of the spring.

70. The device of any preceding claim wherein the buffering unit is positioned on the central shaft between the two mirrored input interfaces and is configured for the coupling of the input interfaces providing for the forced counter movement of the handles, by having the secondary gear(s) engage with the primary gears of both input interfaces, and wherein the buffering element comprises two separate mirrored spring-load resistance mechanisms comprised in separate compartments (1207) of the buffering unit housing, each where the first protrusions (1101) and second protrusions (1205) are stoppers forming walls in opposite distal ends of each compartment, which upon rotation of the cylinders expands or shrinks the compartments and thereby compressing or decompressing the springs thereby accumulating or releasing energy.

71. The device of claim 60 to 70 wherein the housing encases the buffering unit and the primary gear(s) and comprising two halfshells (1201) fitted together by fastening means (1208), optionally screws, elastic straps, magnets or interlocking mechanism between the two halfshells.

72. The device of any preceding claim wherein the output interface (130) is connected to the central shaft or the cylinder, optionally in an outmost distal end (146), and is configured for connecting the device to the vehicle, optionally to a handle of the vehicle.

73. The device of claim 72 wherein the output interface (130) and the central shaft is connected by fastening means, optionally screws or a socket connection having a male protruding component (147) configured to fit into a corresponding female component (1501) with a hollowed-out socket.

74. The device of claim 72 to 73 wherein the output interface (130) comprises (i) a first connector element (150) connecting to the central shaft or the cylinder, (ii) a second connector element (151) joined to the first connector element by a first joint (152) and comprising one or more attachment points (153) for attaching the second connector element to the vehicle and (iii) a third connector element (154) joined to the second connector element by a second joint (155) and comprising one or more further attachment points (153) for attaching the third connector element to the vehicle.

75. The device of claim 74 wherein the first and the second joints are selected from fixed joint, revolute or pivot joint, prismatic joint, ball and socket joint, planar joint, universal joint also known as a cardan joint, cylindrical joint.

76. The device of claim 75 wherein the first and the second joints (152/155) are pivot joints, optionally having one or more matching taps fitted into each other held together with a central pin.

77. The device of claim 75 to 76 wherein the connector elements of the output interface is flexible joint, allowing the positioning of the connector elements to be adjusted in at least two dimensions relative to each other.

78. The device of claim 74 to 77 wherein the attachment points are cut-outs or holes in the connector element configured for accommodating fastening means (157) fitted into the attachment points and configured for fastening the connector element to the vehicle.

79. The device of claim 78 wherein the fastening means (157) are adjustable and releasable and configured for fastening the connector element to the vehicle.

80. The device of claim 78 to 79 wherein the fastening means (157) are selected from strips, claws, elastic bands, or hook and loop bands.

81. The device of claim 78 to 80 wherein the fastening means (157) is a strip comprising a ladderstap (158) and a racket (159).

82. The device of claim 74 to 81 wherein the length of the first connector element in its longitudinal direction is between 25 mm to 75 mm, optionally between 40 mm to 50 mm, optionally between 40 mm to 50 mm, optionally between 47 mm to 49 mm.

83. The device of claim 74 to 82 wherein the length of the second connector element in its longitudinal direction is between 150 mm to 200 mm, optionally between 170 mm to 190 mm, optionally between 181 mm to 183 mm.

84. The device of claim 74 to 83 wherein the length of the third connector element in its longitudinal direction is between 50 mm to 100 mm, optionally between 60 mm to 80 mm, optionally between 70 mm to 72 mm.

85. The device of claim 74 to 84 wherein the combined length in the longitudinal direction of the first, second and third connector element of the output interface is between 225 mm to 500 mm long, optionally between 250 mm to 400 mm long, optionally between 275 mm to 350 mm, optionally between 300 mm to 302 mm.

86. The device of any preceding claim wherein the output interface (130) is connected to the central shaft or the cylinder, optionally in an outmost distal end (146), and is configured for connecting the device to the vehicle, optionally to a handle of the vehicle, wherein the output interface (130) and the central shaft is connected by fastening means, optionally screws or a socket connection having a male protruding component (147) configured to fit into a corresponding female component (1501) with a hollowed-out socket, wherein the output interface (130) comprises (i) a first connector element (150) connecting to the central shaft or the cylinder, (ii) a second connector element (151) joined to the first connector element by a first joint (152) and comprising one or more attachment points (153) for attaching the second connector element to the vehicle and (iii) a third connector element (154) joined to the second connector element by a second joint (155) and comprising one or more further attachment points (153) for attaching the third connector element to the vehicle, wherein the first and the second joints (152/155) are pivot joints having one or more matching taps fitted into each other held together with a central pin, wherein the connector elements of the output interface is flexibly joined, allowing the positioning of the connector elements to be adjusted in at least two dimensions relative to each other, wherein the attachment points are cut-outs or holes in the connector element configured for accommodating fastening means (157) fitted into the attachment points and configured for fastening the connector element to the vehicle, wherein the fastening means (157) are adjustable and releasable strips comprising a ladderstap (158) and a racket (159) configured for fastening the connector element to the vehicle, wherein the length of the first connector element in its longitudinal direction is between 47 mm to 49 mm, wherein the length of the second connector element in its longitudinal direction is between 181 mm to 183 mm, wherein the length of the third connector element in its longitudinal direction is between 70 mm to 72 mm, and wherein the combined length in the longitudinal direction of the first, second and third connector element of the output interface is between 300 mm to 302 mm.

87. The device of any preceding claim wherein the device comprises a synthetic polymeric material, optionally reinforced by inorganic fibres.

88. The device of claim 87 wherein the cylinder, the central shaft, the buffering unit housing and the output interface connector elements comprises a synthetic polymeric material reinforced by inorganic fibres.

89. The device of claim 88 wherein the synthetic polymeric material is a polyamid (nylon) and the inorganic fibres are glass fibres or any composites thereof.

90. The device of claim 89 wherein the synthetic polyamid comprises between 10% to 50% glass fibres, optimally between 20% to 40%, optionally between 25% to 35%, optionally between 29% to 31%.

91. The device of claim 89 wherein the polyamid is a polyamid 6.

92. The device of claim 87 wherein the gears comprise a polyoxymethylene (POM) synthetic polymeric material.

93. The device of claim 87 wherein the handle comprises a synthetic polymeric material reinforced by inorganic fibres.

94. The device of claim 93 wherein the synthetic polymeric material is a polypropylene (PP) and the inorganic fibres are glass fibres or any composites thereof.

95. The device of claim 94 wherein the PP comprises between 10% to 50% glass fibres, optimally between 20% to 40%, optionally between 25% to 35%, optionally between 29% to 31%.

96. The device of claim 87 wherein the fastening means configured for fastening the connector element to the vehicle are strips comprising a thermoplastic polyolefin polymer.

97. The device of claim 87 wherein the handle comprises a non-slip sleeve comprising a thermoplastic elastomer.

98. The device of claim 87 wherein the device comprises a spring-load mechanism, wherein the spring is made of stainless steel, or galvanized steel or a functional alloy thereof.

99. The device of claim 87 wherein the handle comprises a bolt and optionally a nut wherein the bolt and optional nut is made of steel or a functional alloy thereof or is made of a synthetic polymeric, optionally a polyamid (nylon).

100. The device of claim 87 wherein the means for fastening the first connector element of the output interface to the central shaft is a screw made of steel or a functional alloy thereof.

101. The device of claim 87 comprising a bearing wherein the bearing is made of steel or a functional alloy thereof.

102. The device of any preceding claim wherein the fluctuating power is the push from a body part of a human in walking or running motion.

103. The device of any preceding claim wherein the fluctuating power is the push from the hand of a human in walking or running motion.

104. The device of any preceding claim wherein the vehicle is a hand pushed vehicle selected from a baby carrier, a baby stroller, a baby jogger, a hand cart, a utility cart, or a wheelbarrow.

105. A method for transforming a fluctuating force comprising connecting the device of claims 1 to 104 to a vehicle, applying a fluctuating force to the device, transforming the fluctuating force in the buffering unit and transfer the transformed force to the vehicle.

106. Use of the device of claims 1 to 104 for applying a force to a vehicle.
